(19) United States
(12) Patent Application Publication
(10) Pub. No.: US 2008/0102925 A1
(43) Pub. Date: May 1, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/790,194

(22) Filed: Apr. 24, 2007

Related U.S. Application Data
(60) Provisional application No. 60/854,068, filed on Oct. 25, 2006.

(51) Int. Cl. A63F 13/00

(52) U.S. Cl. 463/20

(57) ABSTRACT

A slot machine is adapted, with respect to a particular symbol selected by a player making a pressing operation to a touch panel, to have fixed a coinciding symbol neighboring a selected particular symbol and coinciding with the selected particular symbol, and raise a tonal scale of a stopping sound of symbols from a low pitch to a high pitch, in dependence on an increased number of such coinciding symbols.

### CROSS REFERENCE TO RELATED APPLICATION

This application claims priority to co-pending U.S. provisional patent application Ser. No. 60/854,068 entitled “SLOT MACHINE AND PLAYING METHOD THEREOF” filed on Oct. 25, 2006 and naming Kazuo OKADA as inventor, and which is incorporated by reference herein for all purposes.

### BACKGROUND OF THE INVENTION

1. Field of the Invention

The present invention relates to a slot machine for playing games by using a game medium such as a coin or bill, and a playing method thereof.

2. Description of Related Art

As conventional slot machines, as having been disclosed in U.S. Pat. No. 6,604,999 B2, such ones are known that make a payout for a winning combination rearranged on a payline of a display, as well as for a prescribed number of or more prescribed symbols rearranged on a display.

Further, U.S. Pat. No. 6,093,102 A has disclosed a slot machine that makes a payout for a winning combination rearranged on a pattern of paylines that can be increased by a player's selection.

### SUMMARY OF THE INVENTION

According to a first aspect of the present invention, a slot machine comprises a display for displaying a plurality of symbols arranged thereon, a controller for executing a basic game for automatically rearranging a plurality of symbols arranged on the display, and a control input signal switch capable of a selecting operation for selecting a symbol rearranged in the basic game, wherein the controller is adapted, in games after a game in which a selecting operation of the control input signal switch is made, to execute over a prescribed number of games a process for having, in a case where, among symbols rearranged in the game, a symbol neighboring a particular symbol selected by the selecting operation of the control input signal switch is an identical symbol to the particular symbol, that symbol fixed, and change a sound to be produced when symbols are rearranged, in dependence on an increased number of fixed symbols identical to the particular symbol.

According to a second aspect of the present invention, a slot machine comprises a display for displaying a plurality of symbols arranged thereon, a controller for executing a basic game for automatically rearranging a plurality of symbols arranged on the display, and a control input signal switch capable of a selecting operation for selecting a symbol rearranged in the basic game, wherein the controller is adapted, in games after a game in which a selecting operation of the control input signal switch is made, to execute over a prescribed number of games a process for having, in a case where, among symbols rearranged in the game, a symbol neighboring a particular symbol selected by the selecting operation of the control input signal switch is an identical symbol to the particular symbol, that symbol fixed, and raise a tonal scale of a stopping sound to be produced when symbols are rearranged, in dependence on an increased number of fixed symbols identical to the particular symbol.

According to a third aspect of the present invention, a slot machine comprises a display for displaying a plurality of symbols arranged thereon, a controller for executing a basic game for automatically rearranging a plurality of symbols arranged on the display, and a control input signal switch capable of a selecting operation for selecting a symbol rearranged in the basic game, wherein the controller is adapted, in games after a game in which a selecting operation of the control input signal switch is made, to execute over a prescribed number of games a process for having, in a case where, among symbols rearranged in the game, a symbol neighboring a particular symbol selected by the selecting operation of the control input signal switch is an identical symbol to the particular symbol, that symbol fixed, and increase a tonal volume of a stopping sound to be produced when symbols are rearranged, in dependence on an increased number of fixed symbols identical to the particular symbol.

According to a fourth aspect of the present invention, a slot machine comprises a display for displaying a plurality of symbols arranged thereon, a controller for executing a basic game for automatically rearranging a plurality of symbols arranged on the display, and a control input signal switch capable of a selecting operation for selecting a symbol rearranged in the basic game, wherein the controller is adapted, in games after a game in which selecting operations of the control input signal switch are made, to execute over a prescribed number of games a process for having, in a case where, among symbols rearranged in the game, symbols neighboring particular symbols selected by the selecting operations of the control input signal switch are identical symbols to the particular symbols, those symbols fixed, and change a sound to be produced when symbols are rearranged, in dependence on an increased number of fixed symbols identical to the particular symbols.

According to a fifth aspect of the present invention, a slot machine comprises a display for displaying a plurality of symbols arranged thereon, a controller for executing a basic game for automatically rearranging a plurality of symbols arranged on the display, and a control input signal switch capable of a selecting operation for selecting a symbol rearranged in the basic game, wherein the controller is adapted, in games after a game in which a selecting operation of the control input signal switch is made, to execute over a prescribed number of games a process for having, in a case where, among symbols rearranged in the game, a symbol neighboring a particular symbol selected by the selecting operation of the control input signal switch is an identical symbol to the particular symbol, that symbol fixed, and change a stopping sound for announcing a stop of symbols when symbols are rearranged, in dependence on an increased number of fixed symbols identical to the particular symbol.

### BRIEF DESCRIPTION OF THE DRAWINGS

FIG. 1 is a flow chart showing a playing method of a slot machine according to an embodiment of the present invention.

FIG. 2 is a perspective view showing an appearance of the slot machine according to the embodiment of the present invention.

FIG. 3 is an explanatory diagram showing a display region of the slot machine according to the embodiment of the present invention.

FIG. 4 is a diagram showing symbols to be displayed on the slot machine according to the embodiment of the present invention, and code numbers of the symbols.

FIG. 5 is a block diagram showing a control circuit of the slot machine according to the embodiment of the present invention.

FIG. 6 is an explanatory diagram showing a prize table to be referred to in the slot machine according to the embodiment of the present invention.

FIG. 7 is a flow chart showing a procedure of a main process to be executed by the slot machine according to the embodiment of the present invention.

FIG. 8 is a flow chart showing a procedure of a slot game execution process to be executed in the slot machine according to the embodiment of the present invention.

FIG. 9 is a flow chart showing a procedure of a basic game execution process to be executed in the slot machine according to the embodiment of the present invention.

FIGS. 10A and 10B are flow charts showing a procedure of a holding game execution process to be executed in the slot machine according to the embodiment of the present invention.

FIG. 11 is an explanatory diagram showing an example of scrolling symbols in the slot machine according to the embodiment of the present invention.

FIG. 12 is an explanatory diagram showing an example of rearranged symbols in the slot machine according to the embodiment of the present invention.

FIG. 13 is an explanatory diagram showing an exemplary display for notification of a possible pressing operation by use of a touch panel in the slot machine according to the embodiment of the present invention.

FIG. 14 is an explanatory diagram showing an example of rearranged symbols in the slot machine according to the embodiment of the present invention.

FIG. 15 is an explanatory diagram showing an example of fixed or rearranged symbols in the slot machine according to the embodiment of the present invention.

FIG. 16 is an explanatory diagram showing an example of fixed or rearranged symbols in the slot machine according to the embodiment of the present invention.

FIG. 17 is an explanatory diagram showing an example of fixed or scrolling symbols in the slot machine according to the embodiment of the present invention.

FIG. 18 is an explanatory diagram showing an exemplary display for notification of a holding game being executed in the slot machine according to the embodiment of the present invention.

FIG. 19 is an explanatory diagram showing an example of fixed or rearranged symbols in the slot machine according to the embodiment of the present invention.

FIG. 20 is an explanatory diagram showing an example of fixed or rearranged symbols in the slot machine according to the embodiment of the present invention.

FIG. 21 is an explanatory diagram showing an example of fixed or scrolling symbols in the slot machine according to the embodiment of the present invention.

### DETAILED DESCRIPTION OF THE EMBODIMENT

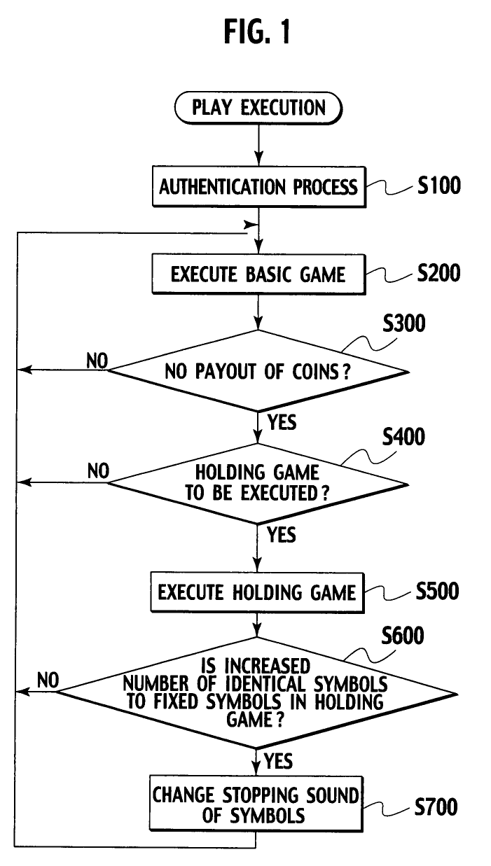

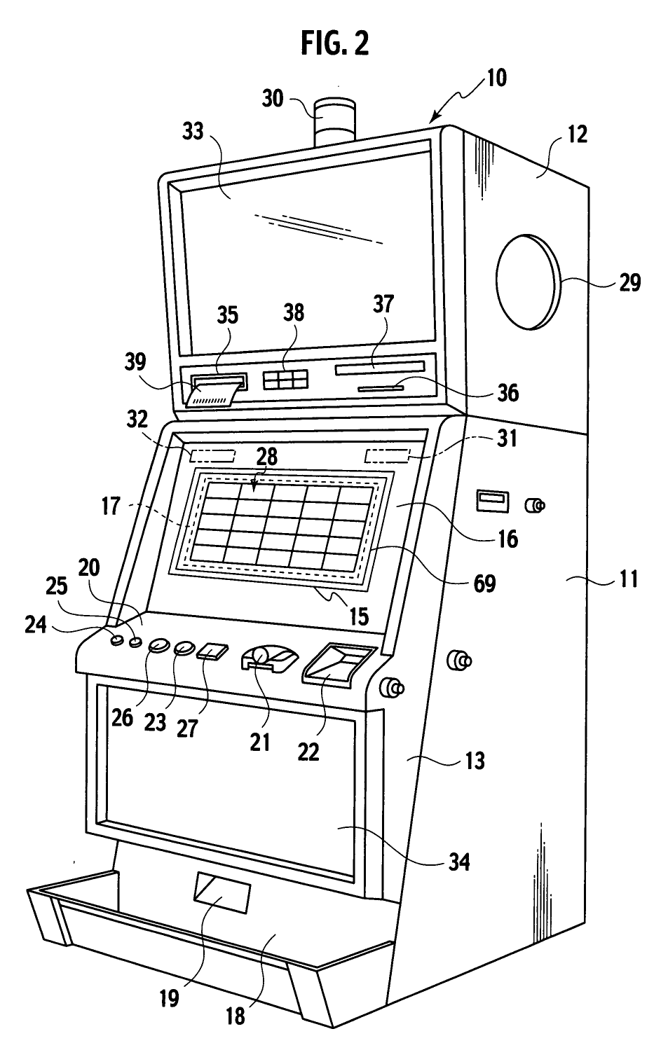

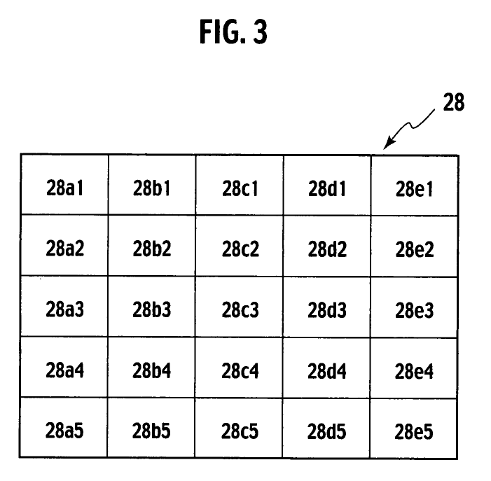

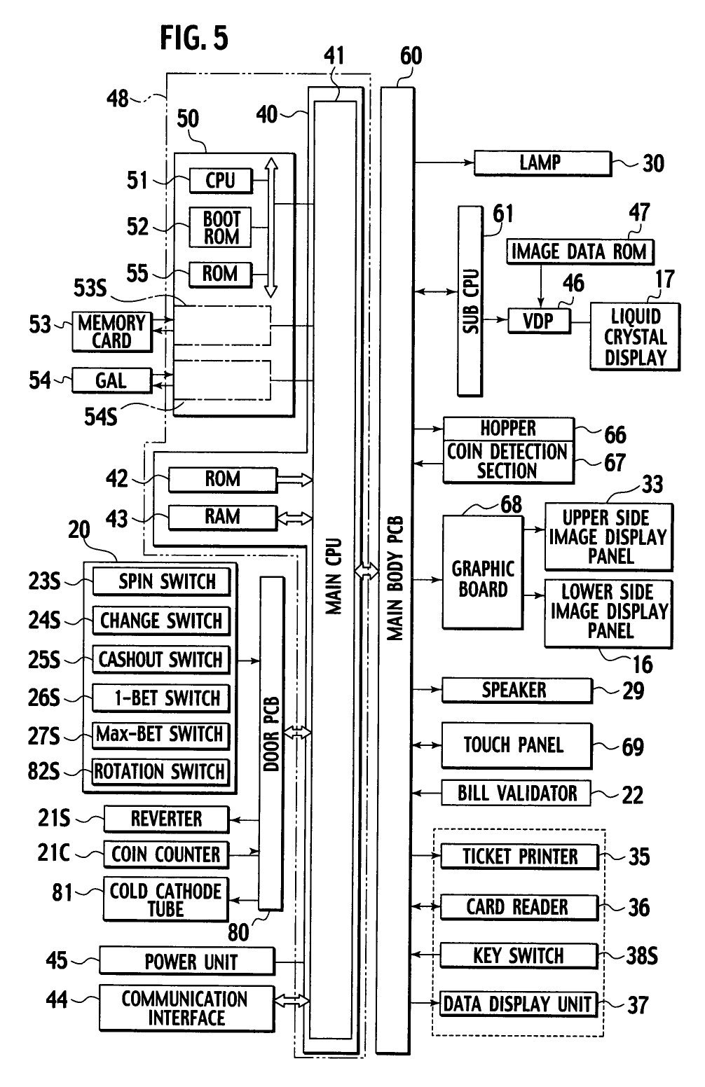

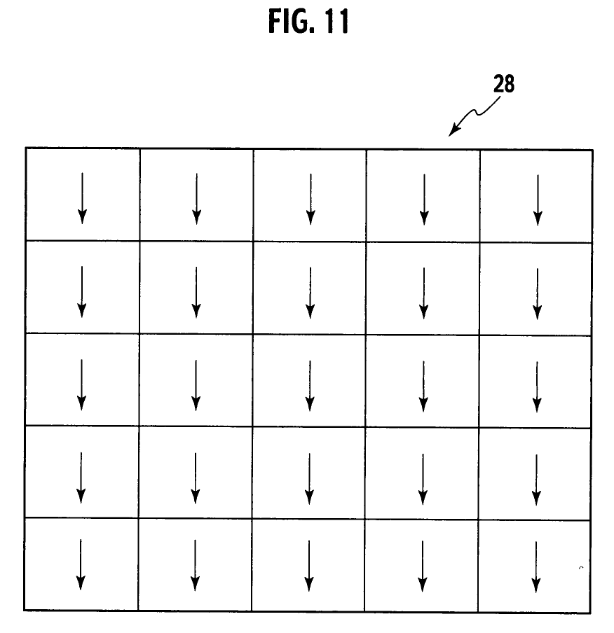

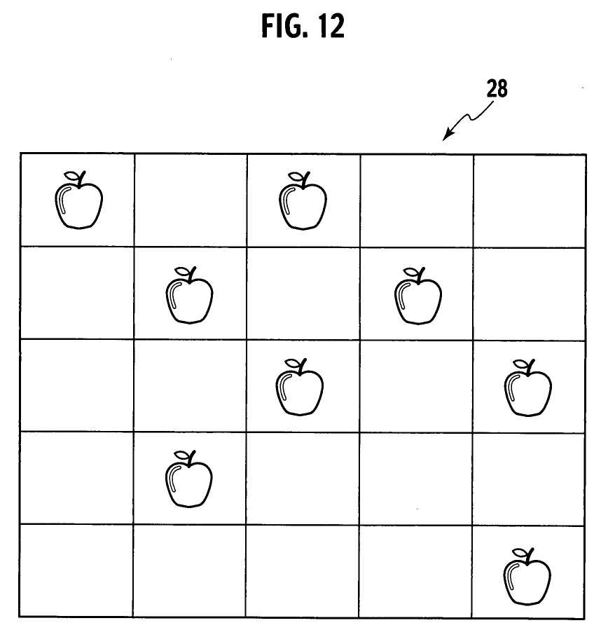

FIG. 1 is a flow chart schematically showing a playing method of a slot machine according to the embodiment of the present invention. There will be described below schematic actions of the slot machine 10 according to this embodiment, with references made to the flow chart shown in FIG. 1, a perspective view shown in FIG. 2, an explanatory diagram of a display region shown in FIG. 3, a block diagram shown in FIG. 5, and explanatory diagrams shown in FIGS. 11 and 12. Note that the slot machine 10 is a stand-alone type slot machine that is not connected to a network, but the present invention is applicable to a slot machine connected to a network as well.

In the slot machine 10 according to the embodiment of the present invention, when the slot machine 10 is started with power applied, it performs an authentication process at a step S100. In this authentication process, initial checking processes are carried out, such as if a program for operating the system normally operates, and if any falsification has been made to the program. More specifically, the following processes are carried out. It is now assumed that in a gaming board 50 of FIG. 5, a memory card 53 is attached to a card slot 53S, and a GAL 54 is attached to an IC socket 54S.

First, with a power switch turned on at a power supply unit 45, a mother board 40 and the gaming board 50 are activated. In the gaming board 50, a CPU 51 reads a preliminary authentication program stored in a boot ROM 52, and follows the read preliminary authentication program to carry out a preliminary authentication for no falsification of the program to be checked and verified in advance before its storage in the mother board 40.

On the other hand, in the mother board 40, a main CPU 41 executes a BIOS (basic input/output system) stored in a ROM 42, developing compressed data incorporated in the BIOS onto a RAM 43. Then, the main CPU 41 executes the BIOS developed on the RAM 43, carrying out diagnoses and initialization of various peripheral devices.

The main CPU 41 reads an authentication program stored in a ROM 55, and stores it in the RAM 43. Next, the main CPU 41 reads a game program and a game system program stored in the memory card 53. Next, the main CPU 41 follows the authentication program stored in the RAM 43 to carry out an authentication for checks for and verification of no falsification made in the read game program and game system program.

After a normal finish of this authentication process, the main CPU 41 stores the authenticated game program and game system program in the RAM 43. Next, the main CPU 41 reads payout rate setting data from a GAL (generic array logic) 54, and stores them in the RAM 43. Next, the main CPU 41 reads country identification information stored in the ROM 55 of the gaming board 50, through a PCI bus, and stores the read country identification information in the RAM 43. By the foregoing, the step S100 has its process finished.

At a step S200, the slot machine 10 executes a basic game. In the basic game, symbols stopped (that is, arranged) in divided regions 28a1 to 28e5 are respectively caused to scroll in the divided regions 28a1 to 28e5 as shown in FIG. 11, and automatically stop (that is, automatically rearranged) as shown in FIG. 12. It is noted that in FIG. 12, symbols other than “APPLE” are omitted. Namely, a display region 28 of a liquid crystal display 17 is divided into divided regions 28a1 to 29e5, so that a symbol scrolls and stops in a respective one of divided regions 28a1 to 28e5. Scrolling and stopped symbols in the divided regions 28a1 to 28e5 are visible to a player through a display window 15. The display window 15 and liquid crystal display 17 thus constitute a display. A payout of coins will be made in accordance with a combination of stopped symbols.

At a step S300, the slot machine 10 determines whether or not a payout of coins should be made depending on a result of the basic game. In the case of determination that a payout of coins should be made, it goes to the step S200, but in the case of determination that no payout of coins should be made, it goes to a step S400.

At the step S400, the slot machine 10 determines whether or not a holding game should be executed. In the case of determination that a holding game should be executed, it goes to a step S500, but in the case of determination that no holding game should be executed, it goes to the step S200.

At the step S500, the slot machine 10 executes a holding game. The holding game is executed a plurality of times. In a first holding game, among symbols stopped in the basic game, there are fixed such a symbol that is selected by a pressing operation (that is, a selecting operation) of a touch panel 69, and such a symbol that neighbors the symbol (particular symbol) selected by the pressing operation of the touch panel 69, at any of upper, lower, left, and right sides thereof, and coincides with the symbol selected by the pressing operation of the touch panel 69. Thereafter, among the symbols stopped in the basic game, other symbols than the fixed symbols scroll, and stop automatically. In a second or any subsequent holding game, besides symbols having been fixed in a previous holding game, such a symbol among symbols stopped in the previous holding game is fixed that neighbors the symbols having been fixed in the previous holding game, at any of upper, lower, left, and right sides thereof, and coincides with the symbols having been fixed in the previous holding game. Thereafter, among the symbols stopped in the previous holding game, other symbols than the fixed symbols scroll, and automatically stop.

At a step S600, the slot machine 10 determines, in a second or subsequent holding game of the holding game to be executed a plurality of times, whether or not it has an increased number of symbols identical to or coinciding with symbols having been fixed in a previous holding game. At a step S700, the slot machine 10 operates, in the case it has an increased number of symbols identical to or coinciding with particular symbols having been fixed in the holding game, to change a stopping sound for announcing a stop of symbols when symbols are rearranged. Namely, it raises a tonal scale of the stopping sound, from a low pitch to a high pitch, in dependence on an increased number of symbols identical to or coinciding with particular symbols having been fixed in the holding game. It may increase a tonal volume of the stopping sound, as well, while raising the tonal scale, in dependence on an increased number of symbols identical to or coinciding with particular symbols having been fixed in the holding game.

Although in this embodiment the holding game is triggered in the case of no payout of coins, a lottery for transfer to a holding game may be separately made to transfer to the holding game. Although description has been made of an example in which a symbol stops to be displayed in each of divided regions 28a1 to 28e5, the present invention is not limited thereto. Namely, it may have also a configuration which employs mechanical rotation reels shaped cylindrical, having a plurality of symbols indicated on their side faces, and in which the rotation reels are rotated and thereafter stopped, so that symbols are stopped inside the display window 15.

Description is now made of configuration of the slot machine 10 according to the embodiment, with reference made to a perspective view shown in FIG. 2. This slot machine 10 is installed within a gaming facility.

In the slot machine 10, as a game medium to be employed for execution of a basic game or holding game, there is a coin, a bill, or a bar-coded ticket 39 corresponding thereto. However, in the present invention, the game medium is not particularly limited, and may be medal, token, and electronic money, for example.

As shown in FIG. 2, the slot machine 10 has a cabinet (casing) 11, a top box 12 installed on an upside of the cabinet 11, and a main door 13 provided on a front of the cabinet 11.

On the main door 13, a lower image display panel 16 is provided. The lower image display panel 16 has a transparent liquid crystal panel, and displays thereon various game-related information, rendering images, etc., when playing a game.

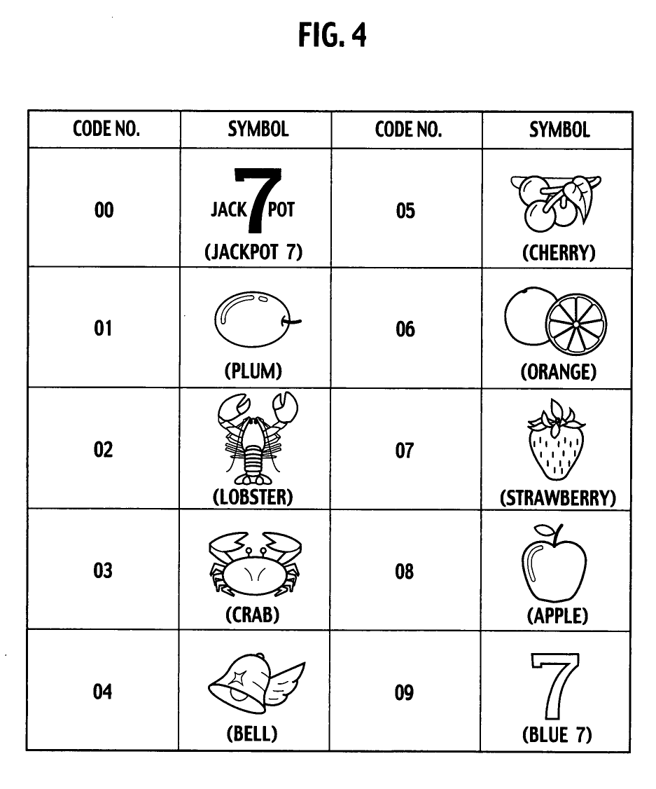

The lower image display panel 16 has a display window 15. At the back of the display window 15, a liquid crystal display 17 is provided. The display region 28 of the liquid crystal display 17 is divided into the divided regions 28a1 to 28e5, as shown in FIG. 3. The liquid crystal display 17 makes a symbol sequence scroll in each of the divided regions 28a1 to 28e5. In this way, the liquid crystal display 17 has a scrolling symbol in each of the divided regions 28a1 to 28e5. Each symbol sequence is made as a combination of a plurality of symbols shown in FIG. 4, and symbol sequences are different from each other. Symbols constituting each symbol sequence are assigned with any code numbers of 00 to 09. For example, a code number “00” is assigned to a symbol “JACKPOT7”. It is noted that letters within parentheses in FIG. 4 indicate names of symbols. The liquid crystal display 17 has a symbol scrolling in each of the divided regions 28a1 to 28e5, and thereafter has a symbol stopped in each of the divided regions 28a1 to 28e5. The scrolling symbol and the stopped symbol in each of the divided regions 28a1 to 28e5 are visible to a player through the display window 15.

It is noted that in this embodiment, symbols are displayed by using the liquid crystal display 17, but it is also possible to provide a plurality of mechanical reels instead of the liquid crystal display 17, and display symbols by using these mechanical reels.

At the front of the display window 15, the touch panel 69 (control input signal switch) is provided. The touch panel 69 is configured so as to face an entirety of the display region 28. When the touch panel 69 is pressed at any part thereof by a player, the touch panel 69 outputs a control input signal corresponding to the pressed part to the main CPU 41 (see FIG. 5).

On the lower image display panel 16, a credit amount display unit 31 and a payout amount display unit 32 are provided. The credit amount display unit 31 displays a total number of coins that the slot machine 10 can pay out to a player (hereafter referred also as “total credit amount”). The total credit amount is stored in the RAM 43 described later. The payout amount display unit 32 displays the number of coins to be paid out in a case where a prescribed number of prescribed symbols are stopped in a basic game or a holding game. It is noted that in the basic game the prescribed number and the prescribed symbol are determined in advance, but in the holding game the prescribed symbol is arbitrarily selective by a player. The prescribed number in the holding game is three or more. These are described later.

Below the lower image display panel 16, a control panel 20 having a plurality of buttons 23-27 through which commands regarding a progress of game are to be input by a player, a coin slot 21 for reception of coin into the cabinet 11, and a bill validator 22 are provided.

On the control panel 20, a spin button 23, a change button 24, a cashout button 25, a 1-bet button 26, and a max-bet button 27 are provided. The spin button 23 is a button operable to input a command for a start of display of scrolling symbols. The change button 24 is a button to be used when requesting a change to an attendant of the gaming facility. The cashout button 25 is a button to input a command for a payout of coins corresponding to a total credit amount to a coin tray 18.

The 1-bet button 26 is a button to input a command for betting to a game one coin among coins corresponding to a total credit amount. The max-bet button 27 is a button to input a command for betting to a game a maximal number (50, for example) of coins that can be bet to a single time of game among coins corresponding to a total credit amount.

The bill validator 22 validates whether a bill is a legitimate one or not and accepts a legitimate bill into the cabinet 11. The bill validator 22 reads the bar-coded ticket 39 described later. Having read a bar-coded ticket 39, the bill validator 22 outputs to the main CPU 41a read signal regarding a read content.

At a lower front of the main door 13, that is, below the control panel 20, there is provided a berry glass 34 on which a character of the slot machine 10 and the like are drawn.

At the front of the top box 12, an upper image display panel 33 is provided. The upper image display panel 33 has a liquid crystal panel, where it displays, for example, a rendering image, or an image for introduction of a content of game or description of a rule of game.

Further, on the top box 12, there is provided a speaker 29 for audio output. Below the upper image display panel 33, there are provided a ticket printer 35, a card reader 36, a data display 37, and a keypad 38. The ticket printer 35 prints on a ticket a bar code that has encoded data, such as on a total credit amount, a credit amount for jackpot, a date and time, an identification number of the slot machine 10, and outputs it as a bar-coded ticket 39. The slot machine 10 determines, in a case where the credit amount for jackpot is greater than a prescribed jackpot threshold (“500”, for example), whether or not a payout of coins corresponding to the credit amount for jackpot should be made. In the case of determination that a payout of coins corresponding to the credit amount for jackpot should be made, the slot machine 10 has symbols “JACKPOT7” stopped in all divided regions 28a1 to 28e5, and makes a payout of coins corresponding to the credit amount for jackpot. It is noted that the credit amount for jackpot is stored in the RAM 43.

It may be allowed for the player to play a game at another slot machine by using a bar-coded ticket 39, or exchange a bar-coded ticket 39 with bills or such at a cashier or the like in the gaming facility.

The card reader 36 reads data from a smart card, and writes data to a smart card. The smart card is a card to be owned by a player, which has stored therein, for example, a data for identification of the player, and data on a history of games the player has done.

The data display 37 is made by a fluorescent display or the like, and displays, for example, data read by the card reader 36, and data input by a player through the keypad 38. The keypad 38 is operable to input data as well as commands for issuance of ticket, etc.

FIG. 5 is a block diagram showing a control circuit of the slot machine 10 shown in FIG. 2. As shown in FIG. 5, the control circuit is made by such components as the mother board 40, a main body PCB (printed circuit board) 60, a sub CPU 61, a gaming board 50, a door PCB 80, various types of switches and sensors, etc. The mother board 40 and the gaming board 50 constitute a controller 48.

The gaming board 50 has the CPU (central processing unit) 51, the ROM 55, and the boot ROM 52 mutually connected through an internal bus, as well as the card slot 53S corresponding to the memory card 53, and the IC socket 54S corresponding to the GAL (generic array logic) 54.

The memory card 53 has a game program and a game system program stored therein. The game program includes a stop symbol determination program. The stop symbol determination program is a program for determining a symbol (code number corresponding to the symbol) to be stopped in each of the divided regions 28a1 to 28e5. This stop symbol determination program contains a symbol weighing data corresponding to a respective one of a plurality of types of payout rates (80%, 84%, and 88%, for example). The symbol weighing data is a data that indicates for each of the divided regions 28a1 to 28e5 a relationship between the code number of each symbol (see FIG. 4), and one or more random values belonging to a prescribed numerical range (0 to 255).

A payout rate is determined in accordance with a payout rate setting data output from the GAL 54, and a symbol weighing data corresponding to this payout rate is based on to determine the symbol to be stopped in each of the divided regions 28a1 to 28e5, and the like.

Further, the card slot 53S is configured for possible insertion and removal of the memory card 53, and is connected to the mother board 40 by an IDE bus. Consequently, by removing the memory card 53 from the card slot 53S, writing another game program together with a game system program to the memory card 53, and inserting the memory card 53 into the card slot 53S, the type as well as the content of the game to be played on the slot machine 10 can be changed.

The game program includes a program relating to the progress of game. Further, the game program contains video data as well as audio data to be output in the game. In addition, the game program contains video data as well as audio data, as notification data for notifying to a player in the way to a holding game, that a pressing operation of the touch panel 69 is enabled, as well as that a holding game is to be executed.

The GAL 54 has a plurality of input ports and output ports, and is adapted, with data input to the input ports, to output data corresponding to those data from the output ports. An output data from an output port is the payout rate setting data described.

Further, the IC socket 54S is configured for possible attachment and detachment of the GAL 54, and is connected to the mother board 40 by a PCI bus. Consequently, by detaching the GAL 54 from the IC socket 54S, rewriting a program stored in the GAL 54, and attaching the GAL 54 to the IC socket 54S, the payout rate setting data to be output from the GAL 54 can be changed.

The CPU 51, ROM 55, and boot ROM 52 mutually connected by internal buses are connected to the mother board 40 by a PCI bus. The PCI bus is responsible for transmission of signals between the mother board 40 and the gaming board 50, and for power supply from the mother board 40 to the gaming board 50. The ROM 55 has country identification information and an authentication program stored therein. The boot ROM 52 has stored therein a preliminary authentication program, a (boot code) program for the CPU 51 to start the preliminary authentication program, and the like.

The authentication program is a program (falsification checking program) for authenticating the game program and the game system program. The authentication program is a program to perform checks for and verification of no falsification made to the game program and the game system program. Namely, the authentication program is written along a procedure for authentication of the game program and the game system program. The preliminary authentication program is a program for authenticating the authentication program described. The preliminary authentication program is written along a procedure for proving that the authentication program as the object to be authenticated is not falsified, that is, for authentication of the authentication program.

The mother board 40 has the main CPU 41, the ROM (read only memory) 42, the RAM (random access memory) 43, and a communication interface 44.

The main CPU 41 is adapted, when a coin as part of coins corresponding to a total credit amount is bet and the spin button 23 is pressed, to output to the sub CPU 61 a scroll command signal for the effect to have the liquid crystal display 17 scroll symbols, and after symbols are scrolled, to determine a symbol to be stopped in each of the divided regions 28a1 to 28e5, and output to the sub CPU 61 a stop command signal for the effect to have the determined symbol stop in each of the divided regions 28a1 to 28e5. The sub CPU 61 performs various processes according to signals given from the main CPU 41.

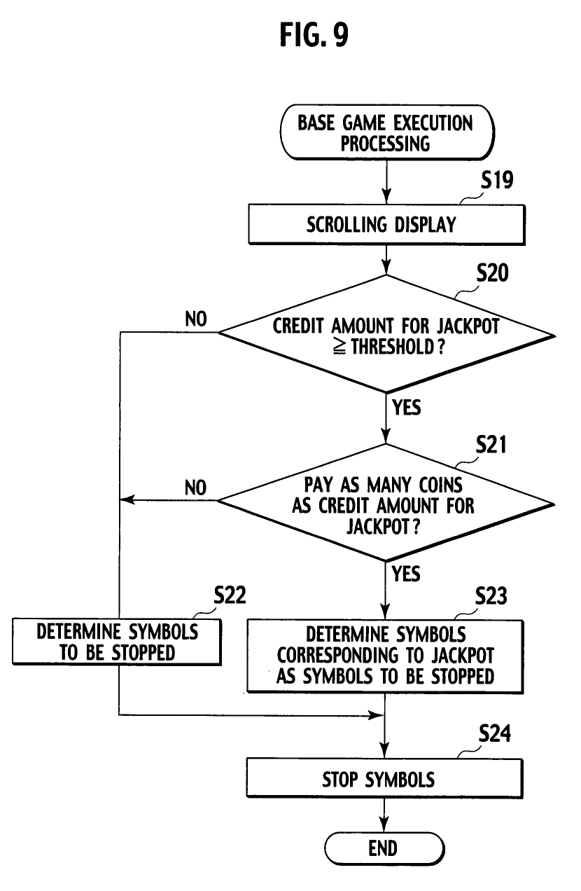

The main CPU 41 executes a holding game when a prescribed condition that will be described later (see steps S15 to S16 of FIG. 8) is met. The holding game will be described into details.

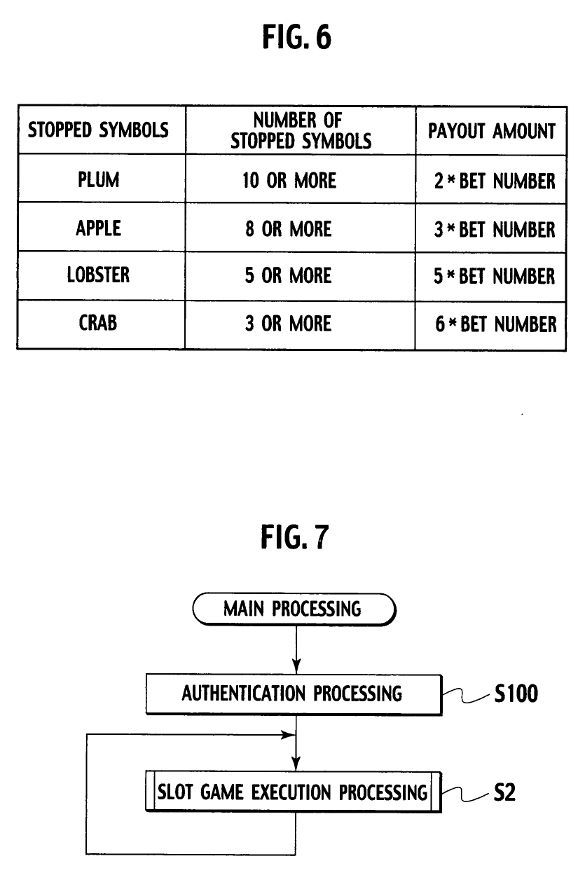

The ROM 42 has stored therein programs, such as a BIOS (basic input/output system), to be executed by the main CPU 41, and data for permanent use. As the BIOS is executed by the main CPU 41, processes for initializing peripherals are carried out, entering a process for reading a game program and a game system program stored in the memory card 53, via the gaming board 50. The ROM 42 has stored therein a prize table shown in FIG. 6. The prize table provides a correspondence relationship between a condition for coin payout and the number of coins to be paid out when the condition is met. The condition for coin payout is given in terms of a symbol stopped in any of the divided regions 28a1 to 28e5, that is, a stopped symbol, and the number of stopped symbols. The main CPU 41 is adapted in the basic game to make, on bases of the prize table and a symbol stopped in each of the divided regions 28a1 to 28e5, a determination as to whether or not a coin payout should be made, and of the number of coins to be paid out. According to the prize table, the payout amount is equal, for example in cases of ten or more “PLUM” symbols stopped in the display region 28, to 2*bet amount, where the bet amount is a number of waged (bet) coins to the gaming machine.

The RAM 43 has stored therein programs as well as data to be used when the main CPU 41 implements a process. Further, the RAM 43 has a region for storing a number n of holding game execution times, a region for storing a number m of stop symbols, a region for storing a credit amount for jackpot, and a region for storing a total credit amount. The number n of holding game execution times and the number m of stop symbols are parameters relating to a holding game. Specifications will be described later.

The communication interface 44 serves for communications, such as with a host computer installed in the gaming facility, via communication channels.

Further, the mother board 40 has later-described main body PCB (printed circuit board) 60 and door PCB 80 each respectively connected thereto by a USB (universal serial bus). In addition, the power supply unit 45 is connected to the mother board 40. With power supplied from the power supply unit 45 to the mother board 40, the main CPU 41 of the mother board 40 is started, supplying power to the gaming board 50 via PCI bus, causing the CPU 51 to start.

The main body PCB 60 and the door PCB 80 have connected thereto apparatuses or devices for generating input signals to be input to the main CPU 41, and apparatuses and devices whose actions are controlled by control signals output from the main CPU 41. The main CPU 41 executes, in accordance with input signals input to the main CPU 41, the game program and the game system program stored in the RAM 43, whereby it implements calculation process to be performed for storage of their results to the RAM 43, as well as processes for sending control signals to respective apparatuses or devices, as control processes for the apparatuses or devices.

The main body PCB 60 has connected thereto a lamp 30, the sub CPU 61, a hopper 66, a coin detector 67, a graphic board 68, the speaker 29, the touch panel 69, the bill validator 22, the ticket printer 35, the card reader 36, a key switch 38S, and the data display 37. The lamp 30 is controlled to turn on and off by the main CPU 41. It is noted that the speaker 29 is adapted under control by the main CPU 41 and the main body PCB 60 to produce a stopping sound for announcing a stop of symbols as will be described later.

The sub CPU 61 serves for symbol scroll and stop in each of the divided regions 28a1 to 28e5 set in the liquid crystal display 17, and is connected to a VDP (video display processor) 46.

The VDP 46 reads video data of symbols stored in a video data ROM 47, and generates scroll images to be displayed on the liquid crystal display 17, outputting the scroll images to the liquid crystal display 17.

The hopper 66 is installed in the cabinet 11, for paying out a prescribed number of coins from a coin payout opening 19 to the coin tray 18, in accordance with a control signal output from the main CPU 41. The coin detector 67 is provided inside the coin payout opening 19, and upon a detection of payout of a prescribed number of coins from the coin payout opening 19, outputs an input signal to the main CPU 41

The graphic board 68 controls displaying images on the upper image display panel 33 and the lower image display panel 16 in accordance with control signals output from the main CPU 41. The credit amount display 31 of the lower image display panel 16 displays thereon a total credit amount stored in the RAM 43. Further, the payout amount display 32 on the lower image display panel 16 displays thereon the number of coins to be paid out. Further, the graphic board 68 has a VDP (video display processor) for generating video data in accordance with a control signal output from the main CPU 41, and a video RAM for temporary storage of video data generated by the VDP.

The bill validator 22 reads an image of bill, and accepts a legitimate bill into the cabinet 11. Further, upon acceptance of a legitimate bill, the bill validator 22 outputs an input signal to the main CPU 41 in accordance with the amount of that bill. The main CPU 41 adds to the total credit amount a credit amount corresponding to the amount of bill informed by the input.

The ticket printer 35 follows a control signal output from the main CPU 41, to print on a ticket a bar code having encoded data such as on a total credit amount stored in the RAM 43, a date and time as well as an identification number of the slot machine 10, and a credit amount for jackpot, and output it as the bar-coded ticket 39.

The card reader 36 performs reading a data from a smart card, for transmission to the main CPU 41, as well as writing a data to a smart card in accordance with a control signal output from the main CPU 41. The key switch 38S is provided on the keypad 38, and upon operation of the keypad 38 by a player, outputs an input signal to the main CPU 41.

The data display 37 displays a data read by the card reader 36 as well as a data input by a player through the keypad 38, in accordance with a control signal output from the main CPU 41.

To the door PCB 80 has connected thereto a control panel 20, a reverter 21S, a coin counter 21C, and the cold cathode tube 81. On the control panel 20, there are provided a spin switch 23S corresponding to the spin button 23, a change switch 24S corresponding to the change button 24, a cashout switch 25S corresponding to the cashout button 25, a 1-bet switch 26S corresponding to the 1-bet button 26, and a max-bet switch 27S corresponding to the max-bet button 27. The switches 23S to 27S are each respectively adapted, upon operation of a corresponding one of the buttons 23-27 by a player, to output an input signal to the main CPU 41.

The coin counter 21C is provided inside the coin slot 21, and validates whether or not a coin inserted into the coin slot 21 is legitimate. Any coin else than a legitimate one is ejected from the coin payout opening 19. Further, the coin counter 21C is adapted, upon detection of a legitimate coin, to output an input signal to the main CPU 41.

The reverter 21S is adapted to operate in accordance with a control signal output from the main CPU 41, for distribution of coins recognized as legitimate coins by the coin counter 21C to the cash box (not shown) provided inside the slot machine 10, or to the hopper 66. Namely, when the hopper 66 is filled with coins, legitimate coins are distributed to the cash box by the reverter 21S. On the other hand, when the hopper 66 is not filled with coins, legitimate coins are distributed to the hopper 66.

The cold cathode tube 81 functions as a back light installed at the back of the lower image display panel 16 and the upper image display panel 33, and is adapted to turn on in accordance with a control signal output from the main CPU 41.

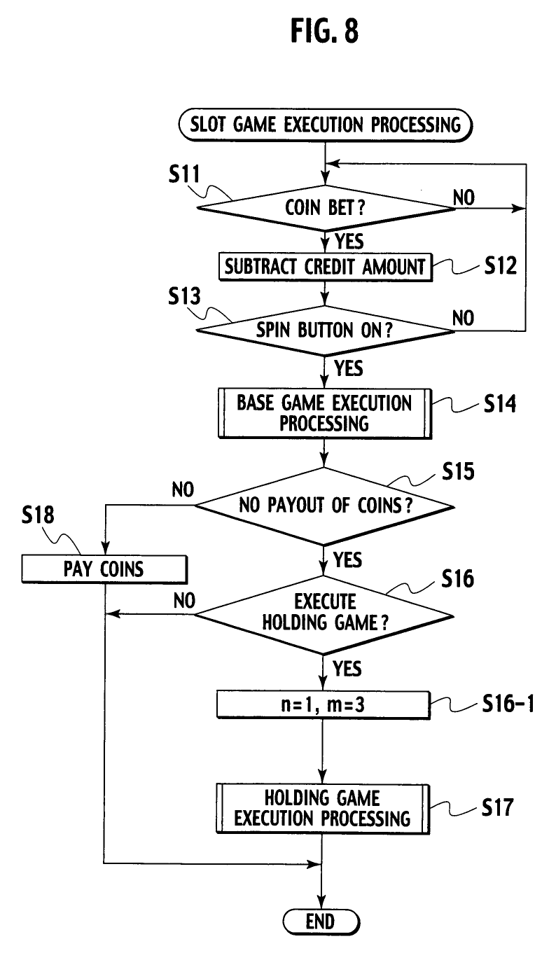

Description is now made of specific processes to be implemented in the slot machine 10. The slot machine 10 implements a main process shown in FIG. 7. Namely, at a step S100, the slot machine 10 performs the authentication process described. Thereafter, the main CPU 41 repeats a slot game execution process shown in FIG. 8.

FIG. 8 is a flow chart showing a procedure of the slot game execution process. At a step S11, the main CPU 41 judges whether a coin bet has been made or not. In this process, the main CPU 41 judges whether or not it has received an input signal to be output from the 1-bet switch 26S when the 1-bet button 26 is pressed or an input signal to be output from the max-bet switch 27S when the max-bet button 27 is pressed. In the case of judgment that no coin bet has been made, the main CPU 41 returns to the step S1, but in the case of judgment that a coin bet has been made, it goes to a step S12. It is noted that the main CPU 41 is adapted, when given a read signal from the bill validator 22, to set a total credit amount and a credit amount for jackpot in accordance with the read signal. Further, the main CPU 41 is adapted, when given an input signal from the coin counter 21C, to set a total credit amount in accordance with the input signal. In addition, the main CPU 41 is adapted, when given an input signal from the bill validator 22, to set a total credit amount in accordance with the input signal.

At the step S12, the main CPU 41 performs a process for subtraction from the total credit amount stored in the RAM 43 in accordance with the number of bet coins, and goes to a step S13. It is noted that the main CPU 41 is adapted, when the number of coins to be bet is greater than the total credit amount stored in the RAM 43 or when the number of coins to be bet exceeds the value of an upper limit (50 in this embodiment) that can be bet to a single time of game, to return the process to the step S11, without performing the process for subtraction from the total credit amount stored in the RAM 43.

At the step S13, the main CPU 41 judges whether the spin button 23 is turned on or not. In this process, the main CPU 41 judges whether or not it has received an input signal output from the spin switch 23S.

In the case of judgment that the spin button 23 is not turned on, the main CPU 41 returns the process to the step S11, but in the case of judgment that the spin button 23 is turned on, it goes to a step S14. It is noted that if a command instructing a finish of game is input without turning the spin button 23 on (as the command instructing a finish of game, there may be, for example, a pressing operation of the cashout button 25 or a request for issuance of the bar-coded ticket 39), the main CPU 41 cancels a result of subtraction at the step S12.

In this embodiment, the main CPU 41 is adapted after a coin bet (step S1) to perform the process for subtraction from the total credit amount (step S12), before the judgment as to whether the spin button 23 is turned on or not (step S13). However, the present invention is not limited to this example. For instance, the main CPU 41 may be adapted after a coin bet (step S121) to judge whether the spin button 23 is turned on or not (step S13), and in the case of judgment that the spin button 23 is turned on (YES at the step S13), to perform the process for subtraction from the total credit amount (step S12).

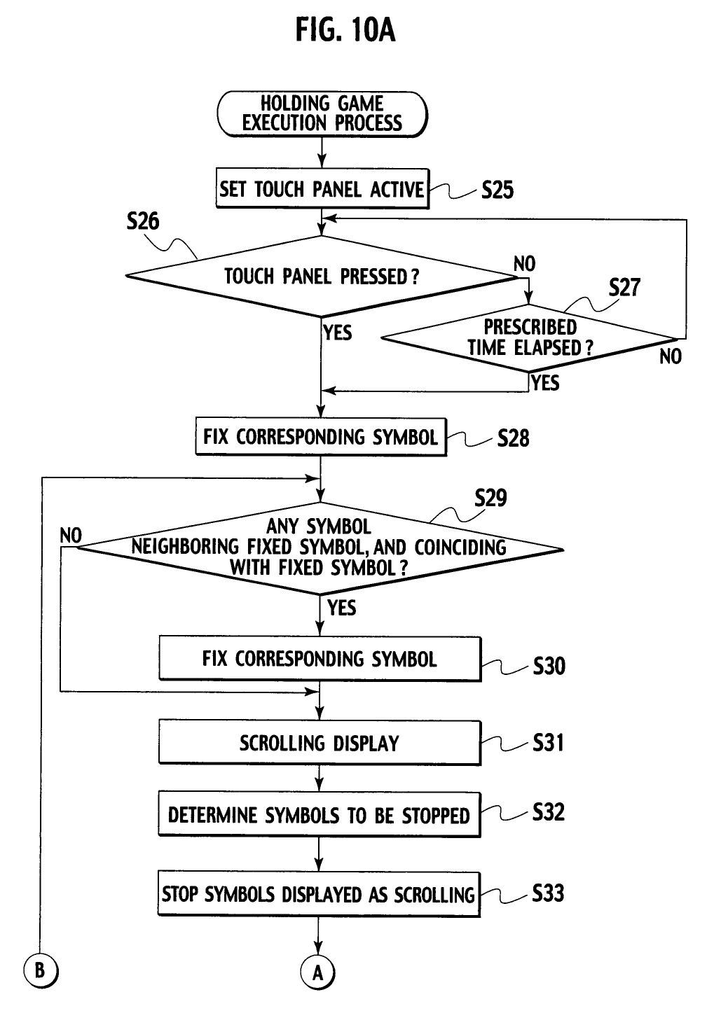

At the step S14, the main CPU 41 carries out a basic game execution process shown in FIG. 9. In outline, the main CPU 41 makes symbols scroll in each of the divided regions 28a1 to 28e5, and has a symbol stopped automatically in each of the divided regions 28a1 to 28e5.

At the step S15, the main CPU 41 determines whether or not a payout of coins should be made in accordance with stopped symbols in the basic game and the prize table shown in FIG. 6. More specifically, it determines that a payout of coins should be made, in the case “JACKPOT7” symbols are stopped in all the divided regions 28a1 to 28e5. On the other hand, in the case a symbol else than “JACKPOT7” is stopped in any of the divided regions 28a1 to 28e5, the main CPU 41 makes a judgment of conditions shown in the prize table, and determines that a payout of coins should be made if any condition shown in the prize table is met, or determines that no payout of coins should be made if no conditions shown in the prize table are met. In the case determination that a payout of coins should be made, the main CPU 41 goes to a step S18, and in the case determination that no payout of coins should be made, it goes to the step S16.

At the step S16, the main CPU 41 determines whether or not a holding game should be executed. More specifically, the main CPU 41 generates a random number within a range of 0 to 65535, and makes a judgment of a condition that the generated random number is included in a prescribed holding game executable range (for example, 1000 to 3000), and determines that a holding game should be executed if the condition is met, or determines that no holding game should be executed unless the condition is met. In the case of determination that a holding game should be executed, the main CPU 41 goes to a step S16-1, but in the case of determination that no holding game should be executed, it ends the slot game execution process.

At the step S16-1, the main CPU 41 sets the number n of holding game execution times to “1”, and sets the number m of stop symbols to “3”.

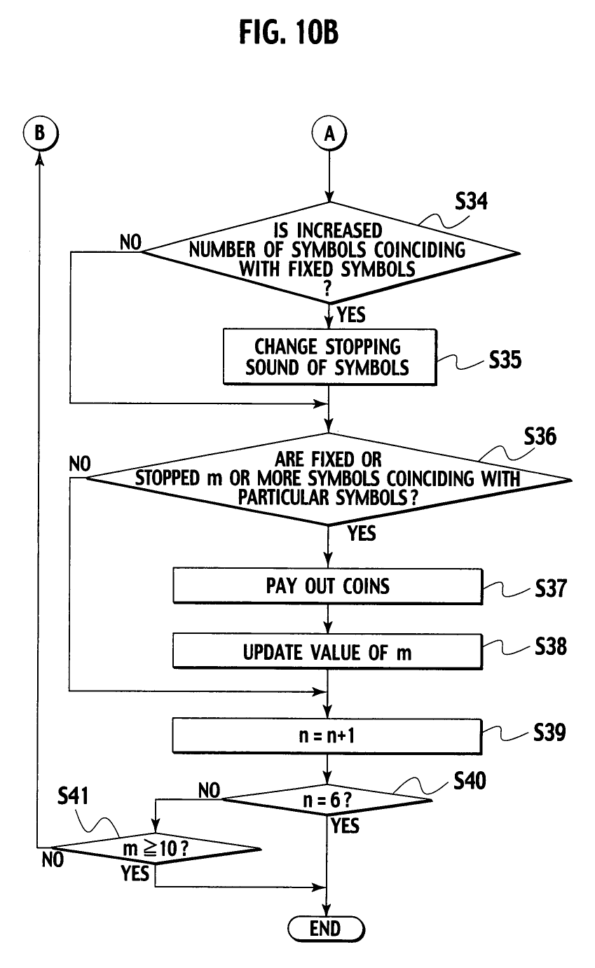

At a step S17, the main CPU 41 implements a holding game execution process shown in FIGS. 10A and 10B. In outline, the main CPU 41 executes a holding game a plurality of times by performing a process of setting the touch panel 69 active, a process of fixing a symbol selected by a pressing operation of the touch panel 69, etc. Thereafter, the main CPU 41 ends the slot game execution process.

At the step S18, the main CPU 41 increases the total credit amount by the credit amount for jackpot, in the case where “JACKPOT7” symbols are stopped in all the divided regions 28a1 to 28e5. On the other hand, in the case where a symbol else than “JACKPOT7” is stopped in any of the divided regions 28a1 to 28e5, the main CPU 41 determines the number of coins to be paid out in accordance with stopped symbols in the basic game and the prize table shown in FIG. 6, while it deposits for jackpot part of coins among the number of coins determined to be paid out, and pays out the rest of coins. More specifically, the main CPU 41 increases the credit amount for jackpot by “3”, and increases the total credit amount by a resultant value of a subtraction of “3” from the number of coins determined to be paid out. For example, if eight “APPLE” symbols are stopped in the basic game as shown in FIG. 12, assuming the bet number to be “5”, the main CPU 41 increases the credit amount for jackpot by “3”, and increases the total credit amount by “12”. Thereafter, the main CPU 41 ends the slot game execution process.

FIG. 9 is a flow chart showing a procedure of the basic game execution process. At a step S19, the main CPU 41 starts a basic game. More specifically, the main CPU 41 outputs to the sub CPU 61 a scroll command signal for the effect to have the liquid crystal display 17 scroll symbols. The sub CPU 61 controls the VDP 46 in accordance with the scroll command signal. Under control by the sub CPU 61, the VDP 46 reads video data of symbols stored in the video data ROM 47, and has a symbol scrolling in each of the divided regions 28a1 to 28e5 of the liquid crystal display 17, whereby the basic game is started. This look is shown in FIG. 11.

At a step S20, the main CPU 41 makes a judgment of a condition that the credit amount for jackpot is equal to or greater than a prescribed jackpot threshold, and if the condition is met, it goes to a step S21, but if the condition is not met, it goes to a step S22.

At the step S21, the main CPU 41 judges whether or not a payout of coins corresponding to the credit amount for jackpot is to be made. More specifically, the main CPU 41 generates a single random number within a range of 0 to 65535, and judges whether or not such a condition is met that the generated random number resides within a prescribed range for jackpot establishment (for example, a range of 150 to 151). As a result, if this condition is met, the main CPU 41 judges that a payout of coins corresponding to the credit amount for jackpot is to be made, but if the condition is not met, it judges that no payout of coins corresponding to the credit amount for jackpot is to be made. The main CPU 41 goes to a step S23 in the case of judgment that a payout of coins corresponding to the credit amount for jackpot is to be made, or to the step S22 in the case of judgment that no payout of coins corresponding to the credit amount for jackpot is to be made.

At the step S22, the main CPU 41 generates a single random number within a range of 0 to 255 for each of the divided regions 28a1 to 28e5. On the basis of 25 random numbers generated, with reference to symbol weighing data depending on payout rate setting data output from the GAL 54 and stored in the RAM 43, the main CPU 41 determines the code number (see FIG. 3) of a symbol to be stopped for each of the divided regions 28a1 to 28e5, whereby the main CPU 41 determines symbols to be stopped in respective divided regions 28a1 to 28e5. It is noted that, at the step S22, it does not occur that the symbols to be stopped in the divided regions 28a1 to 28e5 are all determined to be “JACKPOT7”. Namely, the main CPU 41 is adapted, in the course of determination of a code number corresponding to “JACKPOT7” for all the divided regions 28a1 to 28e5, to have a code number set else than “JACKPOT7” for any one of the divided regions. The main CPU 41 outputs to the sub CPU 61 a stop command signal for stopping the determined symbols in respective divided regions 28a1 to 28e5.

At the step S23, the main CPU 41 determines that the symbols to be stopped in the divided regions 28a1 to 28e5 should be all “JACKPOT7”. The main CPU 41 outputs to the sub CPU 61 a stop command signal for stopping the determined symbol in each of the divided regions 28a1 to 28e5.

At a step S24, the main CPU 41 controls the sub CPU 61 to end the basic game. More specifically, depending on a stop command signal sent from the main CPU 41 (i.e., under control by the main CPU 41), the sub CPU 61 controls the VDP 46. Under control by the sub CPU 61, the VDP 46 reads video data of symbols stored in the video data ROM 47, and stops a symbol in each of the divided regions 28a1 to 28e5 of the liquid crystal display 17. The symbol stopped in each of the divided regions 28a1 to 28e5 coincides with a symbol determined by the main CPU 41. Together with such stopping actions of symbols, the main CPU 41 causes, via the main body PCB 60, the speaker 29 to produce a stopping sound for announcing a stop of symbols.

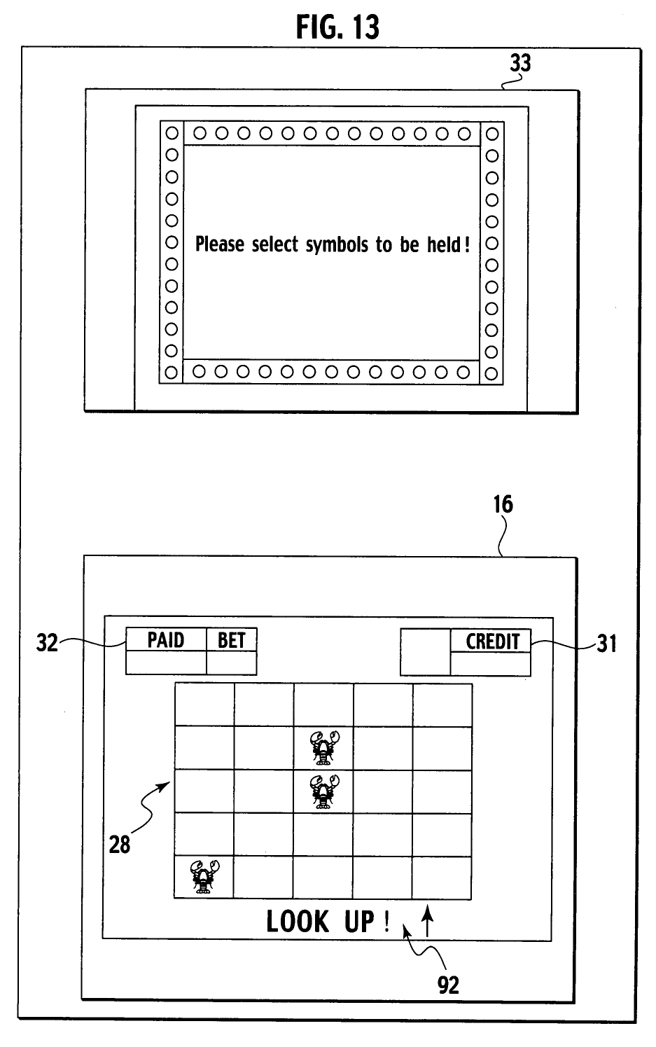

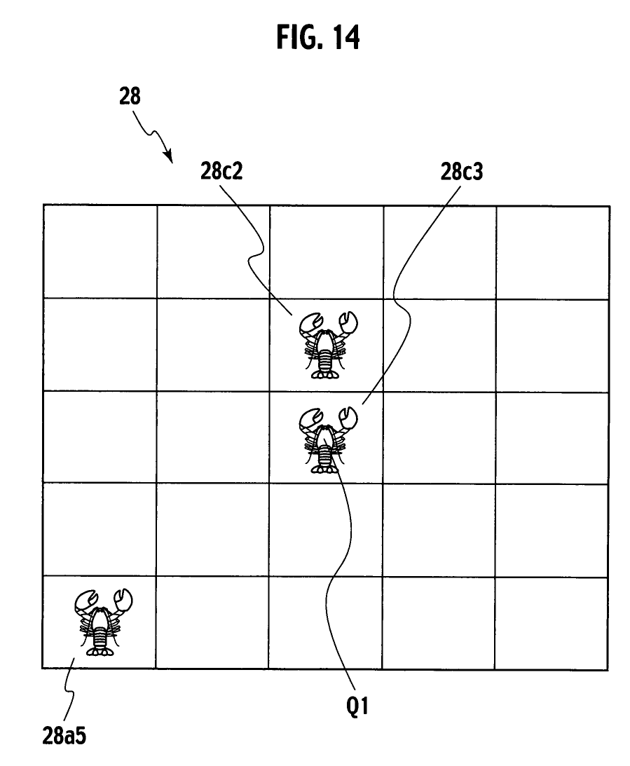

FIGS. 10A and 10B are flow charts showing a procedure of the holding game execution process. At a step S25, the main CPU 41 starts an n-th holding game. Assuming now n=1, the main CPU 41 starts a first holding game. More specifically, the main CPU 41 is enabled to accept (that is, receive) a control input signal from the touch panel 69. At this time point, the basic game has already been finished, and in each of the divided regions 28a1 to 28e5 a symbol having been determined by the main CPU 41 in the basic game is stopped. Further, as shown in FIG. 13, the main CPU 41 displays a phrase “please select symbols to be held!” on the upper image display panel 33 of the slot machine 10. In addition, the main CPU 41 displays an image 92 including an arrow pointing upwards and a phrase “look up!” on a lower part of the lower image display panel 16. In this way, the slot machine 10 is adapted to notify to a player that a first holding game is being executed. It may be concurrently adapted for notification by sound or electric decoration. In the example shown in FIG. 13, as detailed in FIG. 14, a “LOBSTER” symbol is stopped in each of display regions 28a5, 28c2, and 28c3, as a result of basic game. It is noted that in the example shown in FIG. 13 to FIG. 21, any symbols else than “LOBSTER” are omitted.

At a step S26, the main CPU 41 makes judgment of a condition that a pressing operation of the touch panel 69 is made, or more specifically, a condition that a control input signal is given from the touch panel 69, and if this condition is met, it goes to a step S28, but if the condition is not met, it goes to a step S27.

At the step S27, the main CPU 41 makes judgment of a condition that a prescribed interval of time (for example, 10 seconds) has elapsed after a finish of process of the step S25, and if this condition is met, it goes to the step S28, assuming that a control input signal is given from the touch panel 69, but if the condition is not met, it goes to the step S26.

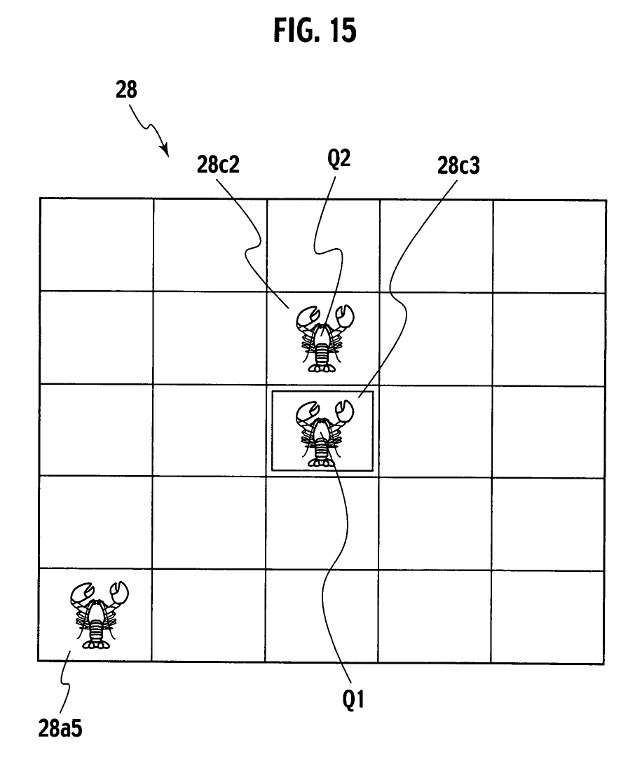

At the step S28, the main CPU 41 specifies a divided region corresponding to the control input signal given from the touch panel 69, as a particular divided region, recognizing that a stopped symbol in the particular divided region is selected by a player. In this way, the player is allowed to select a symbol by a pressing operation to the touch panel 69. In other words, a symbol selected by a player is referred to as “particular symbol”. The main CPU 41 is adapted to fix a particular symbol, and display the fixed particular symbol with emphasis. For instance, assuming a player having selected a stopped symbol Q1 (that is “LOBSTER”) in the divided region 28c3 in the example shown in FIG. 14, the main CPU 41 fixes the symbol Q1 as shown in FIG. 15. Further, the main CPU 41 displays the symbol Q1 with emphasis by enclosing the symbol Q1 with a doubled frame line. In this way, a player is allowed to grasp which symbol is fixed, with ease. Such a configuration may be allowed that a player selects stopped symbols at a plurality of divided regions 28. Such a configuration may also be allowed that a selection is made of different kinds of symbols stopped in a plurality of divided regions 28.

At a step S29, the main CPU 41 makes judgment of a condition that there is a symbol neighboring a fixed particular symbol at any of upper, lower, left, and right sides thereof, and coinciding with the fixed particular symbol (hereafter referred to as “coinciding symbol”, the coinciding symbol including a particular symbol), and if this condition is met, it goes to a step S30, but if the condition is not met, it goes to a step S31.

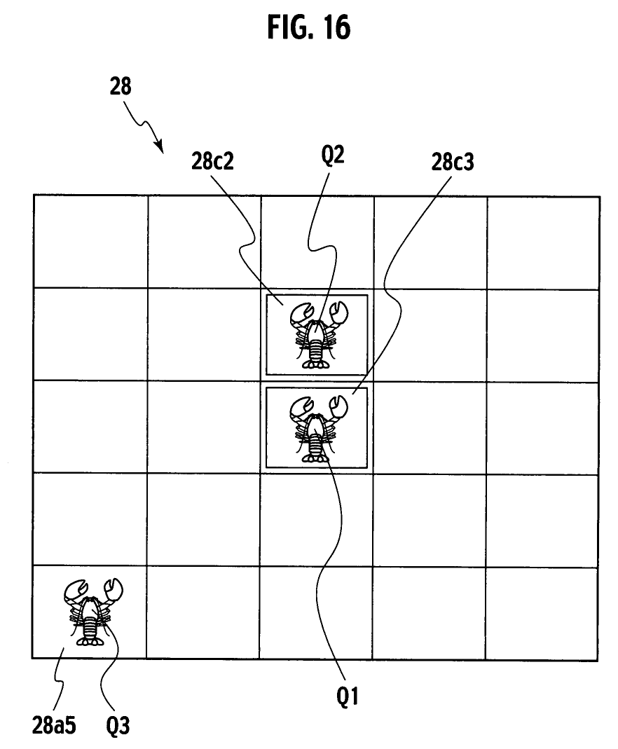

At the step S30, the main CPU 41 fixes a coinciding symbol meeting the condition of the step S29 (that is, a symbol neighboring a fixed particular symbol at any of upper, lower, left and right sides thereof, and coinciding with the fixed particular symbol), and displays the fixed symbol with emphasis. In the example shown in FIG. 15, a symbol Q2 neighbors a fixed symbol Q1 at an upper side thereof and coincides with the fixed symbol Q1, and that the main CPU 41 fixes that symbol Q2 and displays the symbol Q2 with emphasis, as shown in FIG. 16. It is noted that a symbol Q3 coincides with the symbol Q1, but it does not neighbor to the symbol Q1, at any of upper, lower, left, and right sides thereof. Consequently, the main CPU 41 does not fix the symbol Q3.

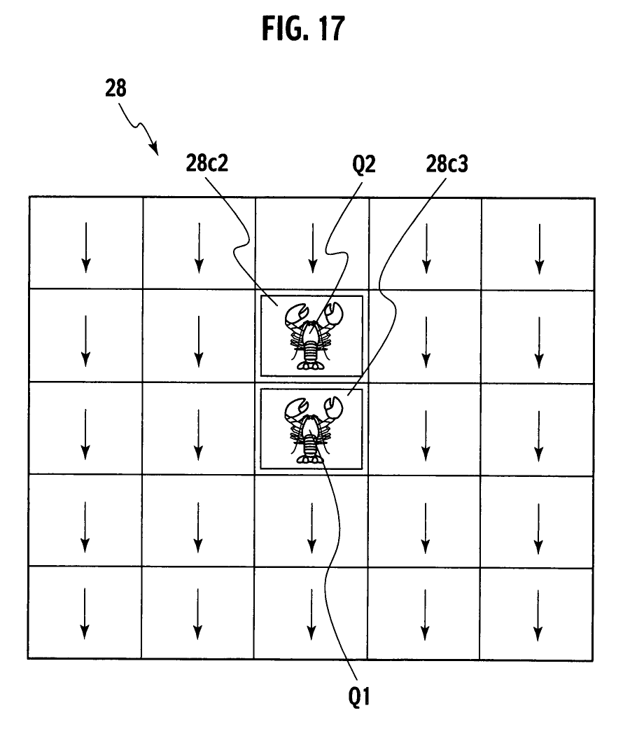

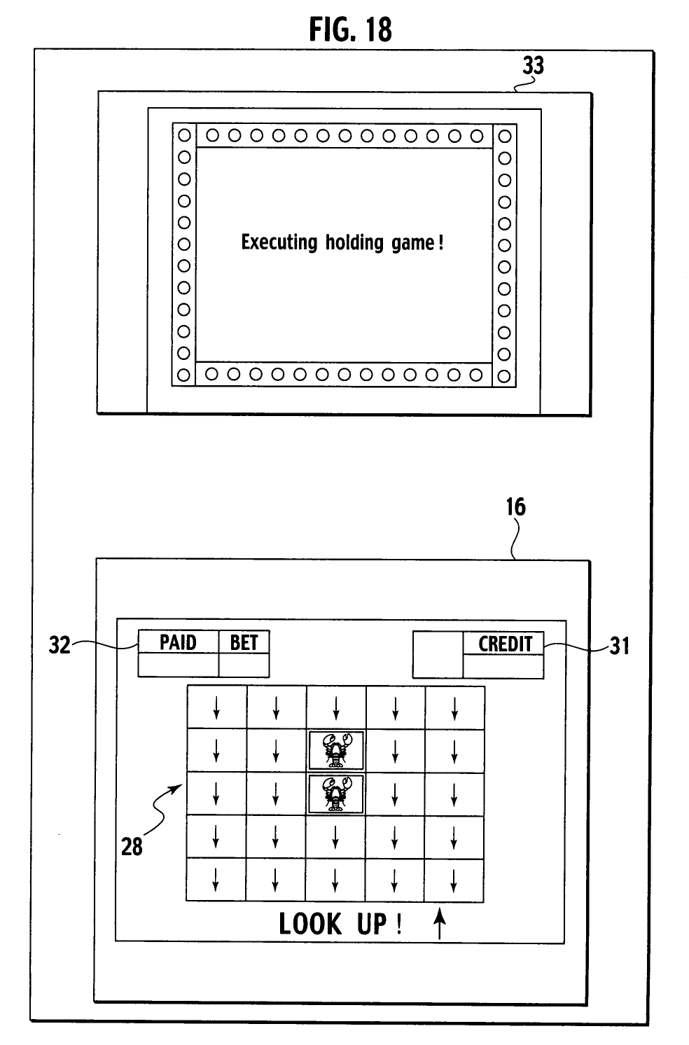

At the step S31, the main CPU 41 outputs a scroll command signal for scrolling symbols other than the fixed symbols, and the sub CPU 61 controls the VDP 46 in accordance with the scroll command signal transmitted from the main CPU 41, so that the VDP 46 scrolls symbols under control by the sub CPU 61. In the example shown in FIG. 16, the symbols Q1 and Q2 are fixed, and other symbols than the symbols Q1 and Q2 are scrolled, as shown in FIG. 17. Further, the main CPU 41 displays a phrase “executing holding game!” on the upper image display panel 33 of the slot machine 10, as shown in FIG. 18.

At a step S32, for each divided region that has a scrolling symbol, the main CPU 41 determines a symbol to be stopped there in a similar process to the process at the step S22. The main CPU 41 generates, and outputs to the sub CPU 61, a stop command signal for the effect to stop the determined symbol.

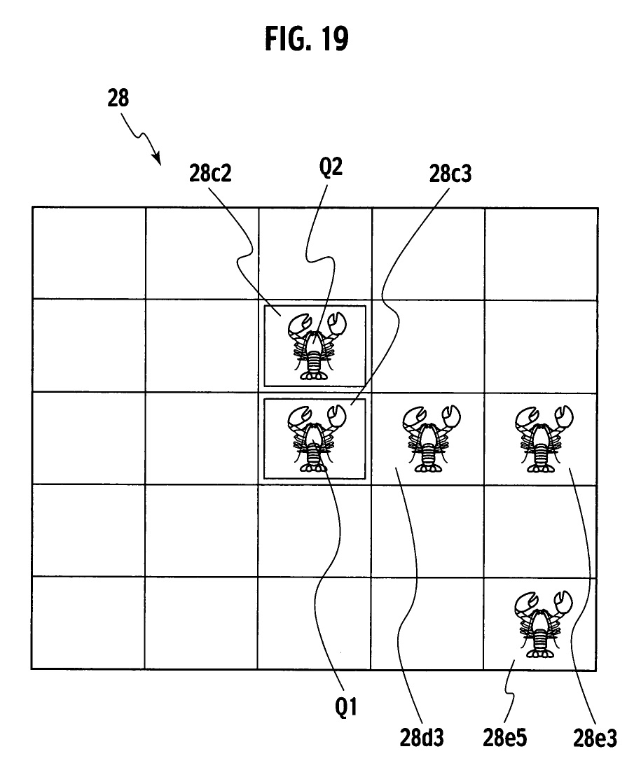

At a step S33, the main CPU 41 makes the n-th holding game end, by controlling the sub CPU 61. More specifically, the sub CPU 61 controls the VDP 46 in accordance with stop command signals transmitted from the main CPU 41 (that is, under control by the main CPU 41), so that the VDP 46 stops symbols under control by the sub CPU 61. As a result, symbols are stopped in other divided regions than the divided regions 28c2 and 28c3, as shown in FIG. 19, for example. In the example shown in FIG. 19, “LOBSTER” symbols are stopped in divided regions 28d3, 28e3, and 28e5.

At a step S34, along with stopping actions of symbols in the step S33, the main CPU 41 makes judgment of a condition that there is an increase in number of coinciding symbols meeting a condition corresponding to the step S29 (that is, symbols each respectively neighboring a fixed symbol, at any of upper, lower, left, and right sides thereof, and coinciding with the fixed symbol), and if this condition is met, it goes to a step S35, but if the condition is not met, it goes to a step S36. In the example shown by FIG. 19, there is an increase, from 1 to 2, in number of coinciding symbols neighboring a fixed symbol Q1, at any of upper, lower, left, and right sides thereof, and coinciding with the fixed symbol Q1 (refer to FIG. 19). Consequently, the condition of the step S34 is met.

At the step S35, if the condition of the step S34 is met, the main CPU 41 drives, with stopping actions of the symbols in the step S33, the speaker 29 to produce a stopping sound for announcing a stop of symbols, in a changing manner. Namely, the main CPU 41 drives, via the main body PCB 60, the speaker 29 to produce a stopping sound, in a manner of raising the tonal scale from a low pitch to a high pitch, each time by three tones, for example, as the number of symbols each respectively identical to or coinciding with any of fixed symbols in the holding game is increased.

It is noted that in the example shown by FIG. 19, there is an increment of one in number of coinciding symbols each respectively neighboring any fixed symbol, at any of upper, lower, left, and right sides thereof, and coinciding with that fixed symbol, and the stopping sound is raised by three tones.

It also is noted that the stopping sound may have an increased tonal volume, as well as an increased tonal scale, as the number of symbols identical to or coinciding with a symbol fixed in the holding game is increased.

At the step S36, the main CPU 41 makes judgment of a condition that m or more coinciding symbols coinciding with the particular symbol are fixed or stopped, and if this condition is met, it goes to a step S37, but if the condition is not met, it goes to a step S39. In the example shown in FIG. 19, coinciding “LOBSTER” symbols are fixed, two in number, and stopped, three in number. Therefore, if m is five or more, the condition of the step S36 is met.

At the step S37, the main CPU 41 increases the credit amount for jackpot by “3”, and increases the total credit amount by (5*r−3), where r is a total number of coinciding symbols at a current time. In the example shown in FIG. 19, r=5.

At a step S38, the main CPU 41 updates the value of m to the total number of coinciding symbols at the current time. In the example shown in FIG. 19, the value of m is updated to “5” in a process of the step S38.

At the step S39, the main CPU 41 increments the value of n by “1”.

At a step S40, the main CPU 41 makes judgment of a condition that the value of n is “6”, and if this condition is met, it ends the holding game execution process, but if the condition is not met, it goes to a step S41.

At the step S41, the main CPU 41 makes judgment of a condition that the value of m is “10” or more, and if this condition is met, it ends the holding game execution process, but if the condition is not met, it returns to the step S29, to thereby start an (n+1)-th holding game.

According to the holding game execution process, the following processes are implemented in the first holding game and in a second or subsequent holding game.

Namely, in the first holding game, among symbols stopped in the basic game, a particular symbol which is selected by a pressing operation (i.e., a selecting operation) of the touch panel 69, and that symbol which neighbors the particular symbol selected by the pressing operation of the touch panel 69, at any of upper, lower, left, and right sides thereof, and coincides with the particular symbol selected by the pressing operation of the touch panel 69 are fixed (refer to the steps S28 to S30). Thereafter, among the stopped symbols in the basic game, other symbols than the fixed symbols scroll (refer to the step S31), and stop automatically (refer to the step S33).

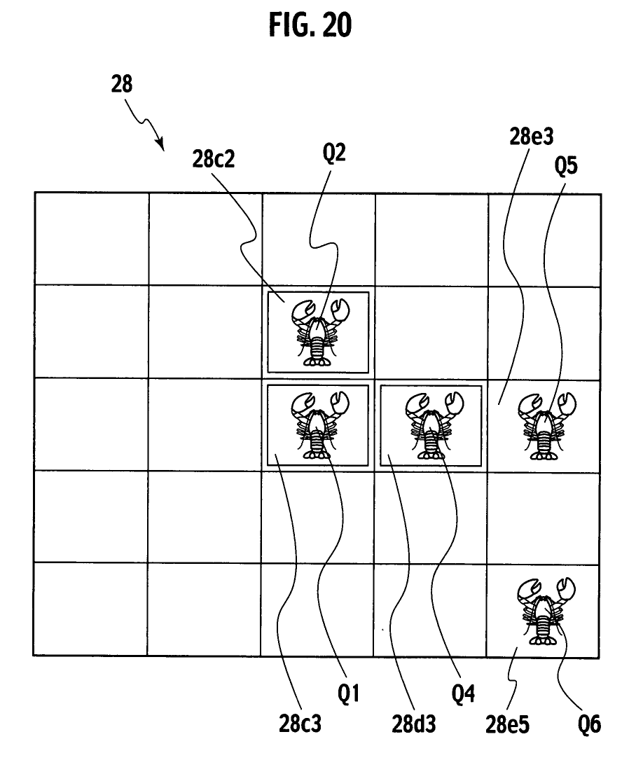

In the second or any subsequent holding game, as illustrated in FIG. 20, among symbols (e.g. Q4, Q5, and Q6 of FIG. 20) stopped (e.g. in the divided regions 28d3, 28e3, and 28e5) in a previous (the first, in the case of FIG. 20) holding game, each coinciding symbol (e.g. Q4 of FIG. 20) that neighbors any (e.g. Q1 of FIG. 20) of fixed symbols (e.g. Q1 and Q2 of FIG. 20) in the previous holding game, at any of upper, lower, left, and right sides thereof, and coincides with that fixed symbol (Q1 of FIG. 20) in the previous holding game is fixed (refer to the step S29), besides the fixed symbols (Q1 and Q2 of FIG. 20) in the previous holding game.

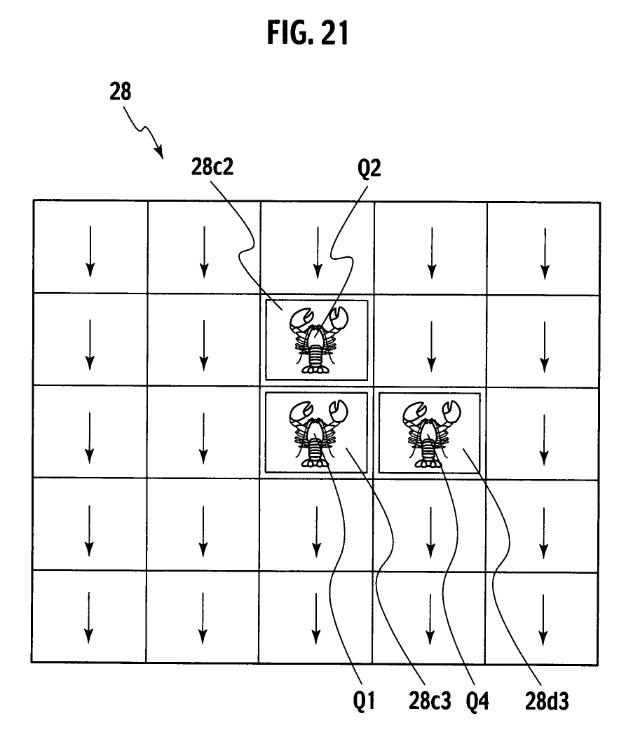

Thereafter, as illustrated in FIG. 21, other symbols than thus fixed symbols (e.g. Q1, Q2, and Q4 of FIG. 21) in the current (n+1)-th holding game scroll (refer to the step S31), and stop automatically (refer to the step S33). Then, the tonal scale of a stopping sound is raised from a low pitch to a high pitch, as the number of symbols identical to or coinciding with any of fixed symbols in the holding game is increased (refer to the steps S34 and S35).

Although, in this embodiment, the slot machine 10 fixes a coinciding symbol neighboring a particular symbol selected by a player at any of upper, lower, left, and right sides thereof and coinciding with the symbol selected by a player, and has a stopping sound of symbols changed, as the number of coinciding symbols is increased, such a change may not be limited to the stopping sound of symbols, and may be implemented of a sound to be produced, for example, when symbols start scrolling, or when symbols are scrolling, (a sound to be produced when rearranging symbols), or the like.

As described above, in the embodiment, the slot machine 10 is adapted to fix a symbol neighboring a particular symbol selected by a player, at any of upper, lower, left, and right sides thereof, and coinciding with the particular symbol selected by a player, and raise a tonal scale of a stopping sound of symbols from a low pitch to a high pitch, with an increase in number of coinciding symbols, allowing for the player to plot, when selecting a symbol, strategies as to which symbol is selective to fix the more symbols, and understand, with the stopping sound having a tonal scale raised from a low pitch to a high pitch, that an increased number of symbols are fixed, thus having an enhanced flush, with a doubled interest to the holding game. Consequently, the slot machine 10 can give the player an increased interest to the holding game, with an enhanced entertainability of the slot machine 10.

Further, with the tonal scale of the stopping sound of symbols being raised from a low pitch to a high pitch, the tonal volume can also be increased, allowing for the more enhanced flush of the player.

In addition, the slot machine 10 provides a holding game in the case no payout of coins is made in a basic game, allowing for the player to have a maintained interest to gaming even after a failed payout of coins in the basic game.

In the above, an embodiment of the slot machine according to the present invention have been described, but they are simply specific examples, with no particular intentions to limit the present invention, and specific configurations of respective means or such can be appropriately changed in design. Further, description of effects in the embodiment of the present invention is a simple iteration of most preferable effects arising from the present invention, and effects of the present invention are not limited to the described effects in the embodiments of the present invention.

What is claimed is:

1. A slot machine, comprising:
a display for displaying a plurality of symbols arranged thereon;
a controller for executing a basic game for automatically rearranging a plurality of symbols arranged on the display; and
a control input signal switch capable of a selecting operation for selecting a symbol rearranged in the basic game,
wherein the controller is adapted, in games after a game in which a selecting operation of the control input signal switch is made, to execute over a prescribed number of games a process for having, in a case where, among symbols rearranged in the game, a symbol neighboring a particular symbol selected by the selecting operation of the control input signal switch is an identical symbol to the particular symbol, that symbol fixed, and change a sound to be produced when symbols are rearranged, in dependence on an increased number of fixed symbols identical to the particular symbol.

2. A slot machine, comprising:
a display for displaying a plurality of symbols arranged thereon;
a controller for executing a basic game for automatically rearranging a plurality of symbols arranged on the display; and
a control input signal switch capable of a selecting operation for selecting a symbol rearranged in the basic game,
wherein the controller is adapted, in games after a game in which a selecting operation of the control input signal switch is made, to execute over a prescribed number of games a process for having, in a case where, among symbols rearranged in the game, a symbol neighboring a particular symbol selected by the selecting operation of the control input signal switch is an identical symbol to the particular symbol, that symbol fixed, and raise a tonal scale of a stopping sound to be produced when symbols are rearranged, in dependence on an increased number of fixed symbols identical to the particular symbol.

3. A slot machine, comprising:
a display for displaying a plurality of symbols arranged thereon;
a controller for executing a basic game for automatically rearranging a plurality of symbols arranged on the display; and
a control input signal switch capable of a selecting operation for selecting a symbol rearranged in the basic game,
wherein the controller is adapted, in games after a game in which a selecting operation of the control input signal switch is made, to execute over a prescribed number of games a process for having, in a case where, among symbols rearranged in the game, a symbol neighboring a particular symbol selected by the selecting operation of the control input signal switch is an identical symbol to the particular symbol, that symbol fixed, and increase a tonal volume of a stopping sound to be produced when symbols are rearranged, in dependence on an increased number of fixed symbols identical to the particular symbol.

4. A slot machine, comprising:
a display for displaying a plurality of symbols arranged thereon;
a controller for executing a basic game for automatically rearranging a plurality of symbols arranged on the display; and
a control input signal switch capable of a selecting operation for selecting a symbol rearranged in the basic game,
wherein the controller is adapted, in games after a game in which selecting operations of the control input signal switch are made, to execute over a prescribed number of games a process for having, in a case where, among symbols rearranged in the game, symbols neighboring particular symbols selected by the selecting operations of the control input signal switch are identical symbols to the particular symbols, those symbols fixed, and change a sound to be produced when symbols are rearranged, in dependence on an increased number of fixed symbols identical to the particular symbols.

5. A slot machine, comprising:
a display for displaying a plurality of symbols arranged thereon;
a controller for executing a basic game for automatically rearranging a plurality of symbols arranged on the display; and
a control input signal switch capable of a selecting operation for selecting a symbol rearranged in the basic game,
wherein the controller is adapted, in games after a game in which a selecting operation of the control input signal switch is made, to execute over a prescribed number of games a process for having, in a case where, among symbols rearranged in the game, a symbol neighboring a particular symbol selected by the selecting operation of the control input signal switch is an identical symbol to the particular symbol, that symbol fixed, and change a stopping sound for announcing a stop of symbols when symbols are rearranged, in dependence on an increased number of fixed symbols identical to the particular symbol.

6. A playing method to be executed by a slot machine, comprising the steps of:
executing a game for automatically rearranging a plurality of symbols arranged on a display;
selecting a symbol rearranged in the game by a selecting operation of a control input signal switch; and
having an adaptation, in games after a game in which a selecting operation of the control input signal switch is made, to execute over a prescribed number of games a process for having, in a case where, among symbols rearranged in the game, a symbol neighboring a particular symbol selected by the selecting operation of the control input signal switch is an identical symbol to the particular symbol, that symbol fixed, and change a sound to be produced when symbols are rearranged, in dependence on an increased number of fixed symbols identical to the particular symbol.

7. A playing method to be executed by a slot machine, comprising the steps of:
executing a game for automatically rearranging a plurality of symbols arranged on a display;
selecting a symbol rearranged in the game by a selecting operation of a control input signal switch; and
having an adaptation, in games after a game in which a selecting operation of the control input signal switch is made, to execute over a prescribed number of games a process for having, in a case where, among symbols rearranged in the game, a symbol neighboring a particular symbol selected by the selecting operation of the control input signal switch is an identical symbol to the particular symbol, that symbol fixed, and raise a tonal scale of a stopping sound to be produced when symbols are rearranged, in dependence on an increased number of fixed symbols identical to the particular symbol.

8. A playing method to be executed by a slot machine, comprising the steps of:
executing a game for automatically rearranging a plurality of symbols arranged on a display;
selecting a symbol rearranged in the game by a selecting operation of a control input signal switch; and
having an adaptation, in games after a game in which a selecting operation of the control input signal switch is made, to execute over a prescribed number of games a process for having, in a case where, among symbols rearranged in the game, a symbol neighboring a particular symbol selected by the selecting operation of the control input signal switch is an identical symbol to the particular symbol, that symbol fixed, and increase a tonal volume of a stopping sound to be produced when symbols are rearranged, in dependence on an increased number of fixed symbols identical to the particular symbol.

9. A playing method to be executed by a slot machine, comprising the steps of:
executing a game for automatically rearranging a plurality of symbols arranged on a display;
selecting a symbol rearranged in the game by a selecting operation of a control input signal switch; and
having an adaptation, in games after a game in which selecting operations of the control input signal switch are made, to execute over a prescribed number of games a process for having, in a case where, among symbols rearranged in the game, symbols neighboring particular symbols selected by the selecting operations of the control input signal switch are identical symbols to the particular symbols, those symbols fixed, and change a stopping sound to be produced when symbols are rearranged, in dependence on an increased number of fixed symbols identical to the particular symbols.

10. A playing method to be executed by a slot machine, comprising the steps of:
executing a game for automatically rearranging a plurality of symbols arranged on a display;
selecting a symbol rearranged in the game by a selecting operation of a control input signal switch; and
having an adaptation, in games after a game in which a selecting operation of the control input signal switch is made, to execute over a prescribed number of games a process for having, in a case where, among symbols rearranged in the game, a symbol neighboring a particular symbol selected by the selecting operation of the control input signal switch is an identical symbol to the particular symbol, that symbol fixed, and change a stopping sound for announcing a stop of symbols when symbols are rearranged, in dependence on an increased number of fixed symbols identical to the particular symbol.
